(19) United States
(12) Patent Application Publication
(10) Pub. No.: US 2015/0026427 A1
(43) Pub. Date: Jan. 22, 2015

(54) DATA REASSIGN METHOD AND STORAGE DEVICE

(71) Applicant: KABUSHIKI KAISHA TOSHIBA, Tokyo (JP)

(72) Inventors: Seiji Toda, Kanagawa (JP); Kiyotaka Sasaki, Kanagawa (JP)

(73) Assignee: KABUSHIKI KAISHA TOSHIBA, Tokyo (JP)

(21) Appl. No.: 14/026,819

(22) Filed: Sep. 13, 2013

Related U.S. Application Data
(60) Provisional application No. 61/847,451, filed on Jul. 17, 2013.

(51) Int. Cl. G06F 3/06

(52) U.S. Cl. CPC G06F 3/0659; G06F 3/0604; G06F 3/0673
USPC 711/165

(57) ABSTRACT

A data reassign method in an embodiment includes: when a reassign command specifying a first logical sector that is included in a first physical sector and that has not been specified yet by the reassign command is received, reassigning data in the first physical sector to a second physical sector different from the first physical sector; and refraining thereafter from reassigning data in the second physical sector until occurrence of either re-receipt of the reassign command for the first logical sector or second-time or later receipt of a reassign command for a second logical sector other than the first logical sector included in the second physical sector.

### CROSS-REFERENCE TO RELATED APPLICATIONS

This application is based upon and claims the benefit of priority from Provisional Patent Application No. 61/847451, filed on Jul. 17, 2013; the entire contents of which are incorporated herein by reference.

### FIELD

Embodiments of the present invention relate to a data reassign method and a storage device.

### BACKGROUND

In the prior art, the HDD (Hard Disk Drive) has a physical sector size of 512 bytes, and has a structure in which additional information such as redundant data exists every sector. However, in recent years, HDDs expanded to 4096 bytes in physical sector size and called “advanced format” have become provided. By doing so, eight pieces required for user data of 4,096 bytes in the prior art can be collected into one piece. As a result, there is a merit that an area where user data is recorded is expanded and it becomes possible to use long redundant data every sector.

However, there are a large number of hosts who still use the logical sector size of 512 bytes. For using an HDD device using the physical sector size of 4,096 bytes in such hosts, the so-called emulation function of behaving to the host as if the sector size is 512 bytes and operating inside with a sector size of 4,096 bytes becomes necessary in the HDD device. If data reassignment with a logical sector taken as the unit is ordered from the host, data is reassigned with a physical sector taken as the unit in the HDD device and consequently reassignment is not executed suitably.

### BRIEF DESCRIPTION OF THE DRAWINGS

FIG. 1 is a diagram illustrating a configuration of a storage device in an embodiment;

FIG. 2 is a diagram illustrating a relation between a physical sector and a logical sector in the embodiment;

FIG. 3 is a diagram for explaining a write operation under execution of an emulation function in the embodiment;

FIG. 4 is a flow chart for explaining a data reassign method in the embodiment;

FIG. 5 is a diagram for explaining a configuration of a REAS flag in the embodiment;

FIG. 6 is a diagram for explaining a REAS flag in an initial state in the embodiment;

FIG. 7 is a diagram for explaining a REAS flag in cases where a REASSIGN BLOCKS command is issued for LBA=4 in the embodiment;

FIG. 8 is a diagram for explaining a REAS flag in cases where the REASSIGN BLOCKS command is issued for LBA=0 in the embodiment; and

FIG. 9 is a diagram for explaining an ordinary area and a reassign area on a medium in the embodiment.

### DETAILED DESCRIPTION

An embodiment of the present invention provides, in a storage device having a recording medium, a data reassign method of rewriting data on the recording medium by taking a physical sector including a plurality of logical sectors each forming a management unit in a command from a host, as a management unit, in response to receipt of a reassign command for rewriting data on the recording medium into a different area from the host. The data reassign method in the embodiment includes: when a reassign command specifying a first logical sector that is included in a first physical sector and that has not been specified yet by the reassign command is received, reassigning data in the first physical sector to a second physical sector different from the first physical sector; and refraining thereafter from reassigning data in the second physical sector until occurrence of either re-receipt of the reassign command for the first logical sector or second-time or later receipt of a reassign command for a second logical sector other than the first logical sector included in the second physical sector.

Hereafter, a data reassign method and a storage device according to an embodiment will be described in detail with reference to the accompanying drawings. Note that the present invention is not restricted by this embodiment.

### Embodiment

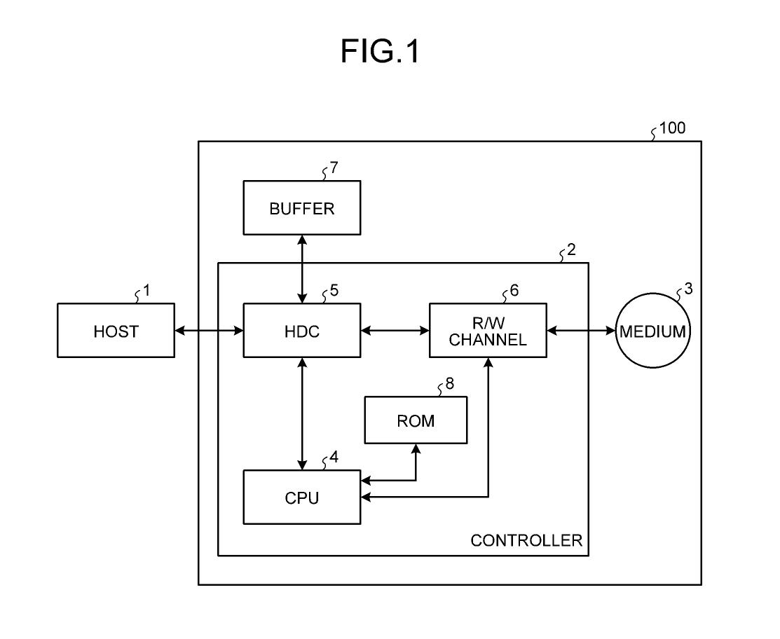

FIG. 1 is a diagram illustrating a configuration of a storage device 100 in an embodiment. The storage device 100 is, for example, an HDD device. The storage device 100 includes a controller 2, a medium 3 which is a recording medium such as a disk, and a buffer 7. The storage device 100 is connected to a host 1. The controller 2 includes a CPU 4, an HDC (Hard Disk Controller) 5, an R/W channel 6, and a ROM 8. The CPU 4 executes reassignment of data in the medium 3 in accordance with firmware stored in, for example, the ROM 8.

To reassign (alternate) data means to copy data in a storage area which has become unusable by some reason such as a failure onto a separately provided reassign area (alternate area). In the present embodiment, a case in which reassignment of data on the medium 3 is executed in accordance with a command from the host 1 will be described. As for a command (reassign command) given by the host 1 to order to reassign data, there is a REASSIGN BLOCKS command as an example of SAS (Serial Attached SCSI). In the ensuing description, this is taken as an example. However, a reassign command given by the host 1 to order to reassign data is not restricted to this.

The R/W channel 6 is a signal processing device configured to process a signal group relating to reading/writing. The R/W channel 6 digitizes read data, and decodes the read data from the digitized data. Furthermore, the R/W channel 6 encodes write data.

The HDC 5 has a host interface function, and the HDC 5 is connected to the host 1. The HDC 5 receives a command transferred from the host 1. The HDC 5 controls data transfer between the host 1 and the HDC 5. The HDC 5 controls data transfer between the medium 3 and the HDC 5. The HDC 5 controls the buffer 7.

The buffer 7 is, for example, a RAM. The buffer 7 temporarily stores data to be written onto the medium 3 and data read out from the medium 3 via the R/W channel 6.

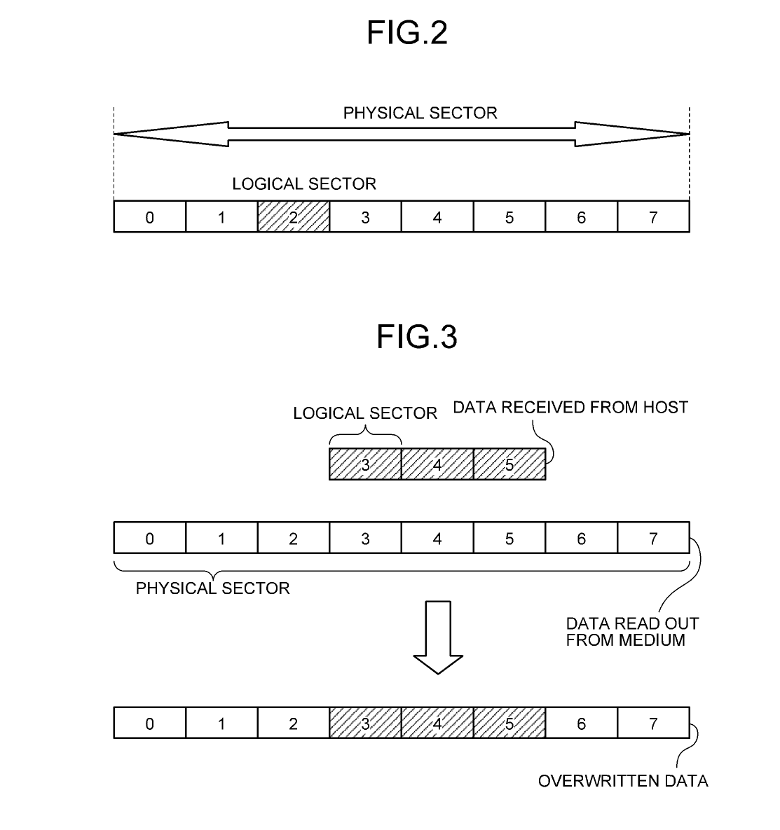

In the present embodiment, the size of a physical sector which is a management unit of reading from and writing onto the medium 3 is greater than the size of a logical sector which is a management unit of reading and writing conducted by the host 1 as illustrated in FIG. 2. For example, supposing that the size of the logical sector is 512 bytes and the size of the physical sector is 4,096 bytes, one physical sector corresponds to eight logical sectors as illustrated in FIG. 2. Hereafter, the present embodiment will be described supposing that one physical sector corresponds to eight logical sectors.

In the case as illustrated in FIG. 2, the storage device 100 has an emulation function of behaving to the host 1 as if the logical sector size is 512 bytes and operating inside with the physical sector size of 4,096 bytes (logical sector size×8). For example, in cases where writing data corresponding to three logical sectors onto the medium 3 is conducted from the host 1, data corresponding to three logical sectors received from the host 1 is overwritten on data corresponding to one physical sector read out from the medium 3 onto the buffer 7 as illustrated in FIG. 3. Thereafter, the overwritten data corresponding to one physical sector is written back onto the medium 3.

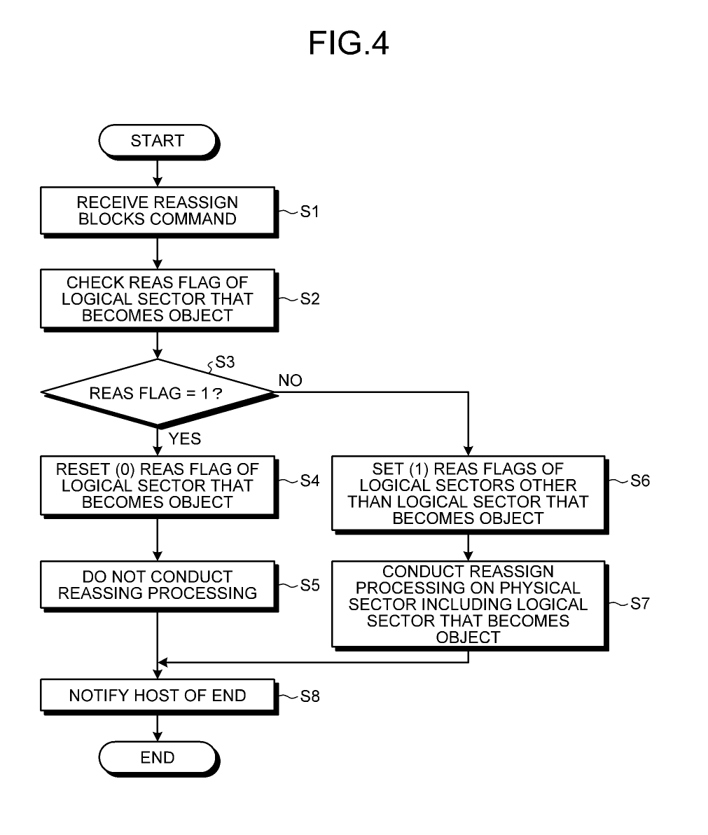

Hereafter, reassign processing of data under execution of the emulation will be described. FIG. 4 is a flow chart of a data reassign method in the embodiment.

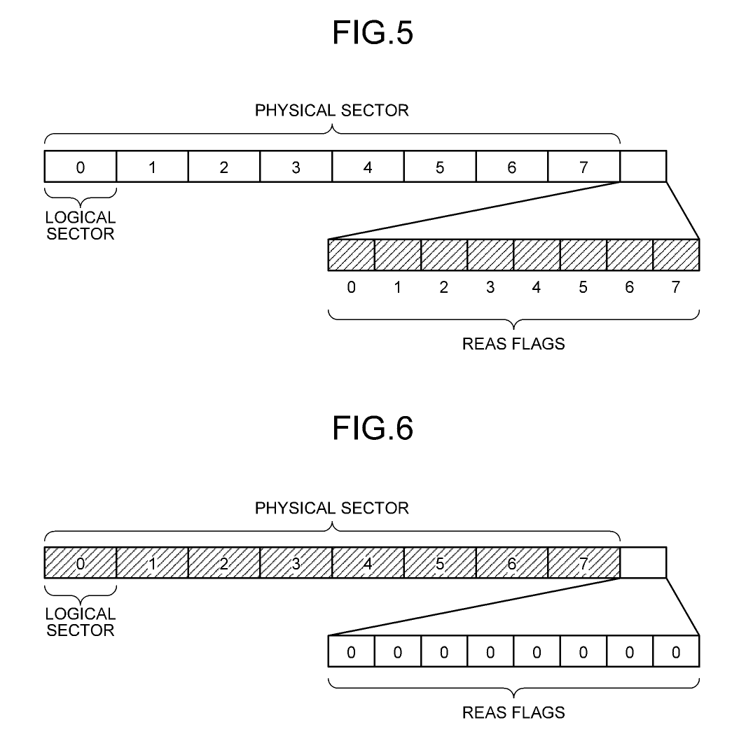

In the present embodiment, REAS flags which are flags (management information) corresponding to the number of logical sectors included in each physical sector of data retained on the medium 3 as illustrated in FIG. 5 are added to each physical sector. In other words, not only the logical sectors but also the REAS flags are retained on the medium 3. The REAS flags are a flag group including a plurality of 1-bit flags respectively corresponding to the logical sectors in the physical sector. If a reassign command is given for a certain logical sector by the host 1, it can be determined on the basis of the REAS flag whether to reassign (copy) a physical sector including the logical sector.

It is supposed that at first all REAS flags corresponding to eight logical sectors (LBA (Logical Block Address)=0 to 7) in a certain physical sector are “0” as illustrated in FIG. 6. This state indicates, for example, a state in which any logical sectors in the physical sector are not specified by a reassign command. If a REASSIGN BLOCKS command is given for a logical sector having a REAS flag “0” by the host 1 in this state, it is necessary to reassign a physical sector including the logical sector. In other words, as for data in a physical sector that is not reassigned once, it is necessary to actually conduct data reassign processing whichever logical sector a reassign command is issued for. In the initial state, therefore, it is necessary that all REAS flags are “0.” Conversely, a REAS flag that is “1” indicates a state in which a physical sector including a corresponding logical sector is already reassigned by a reassign command. Here, it is supposed that “0” indicates that there is no assign execution and “1” indicates that there is assign execution. It should be noted that states indicated by “0” or “1” in the REAS flag may be opposite to those in the above-described example.

Specifically, if the HDC 5 (host interface) receives the REASSIGN BLOCKS command from the host 1 (step S1 in FIG. 4), the HDC 5 checks a REAS flag of a logical sector that becomes an object of the REASSIGN BLOCKS command (step S2). This check is executed by, for example, the CPU 4 via the R/W channel 6. And it is determined whether the REAS flag =1 (step S3). In the case of the initial state illustrated in FIG. 6, all REAS flags are “0.” No matter which logical sector becomes an object of the REASSIGN BLOCKS command, therefore, a result of this determination becomes “NO.”

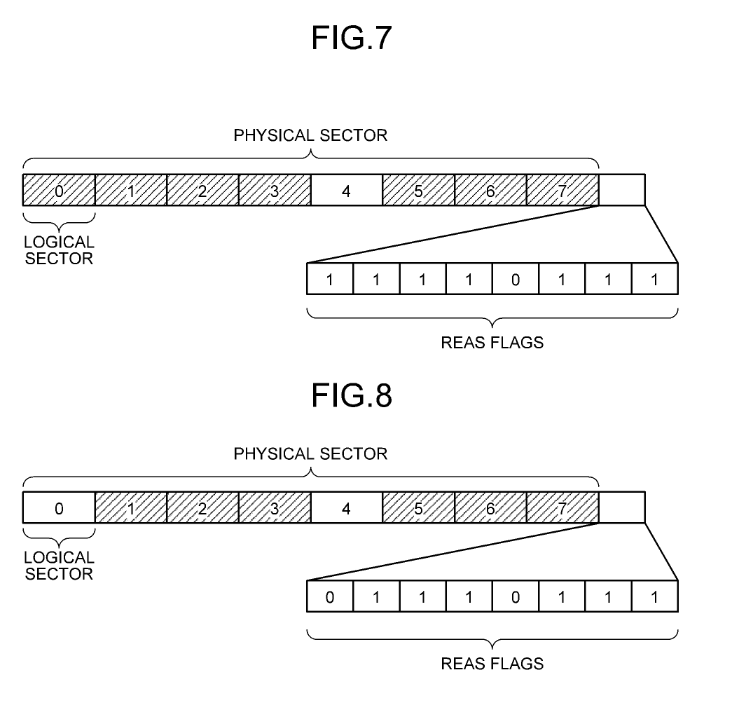

For example, if the REASSIGN BLOCKS command is issued for LBA=4 by the host 1, the REAS flag of the logical sector of LBA=4 illustrated in FIG. 6 is “0” (step S3: No) and consequently all REAS flags of logical sectors other than the logical sector of LBA=4 which becomes the object of the REASSIGN BLOCKS command are set to “1” as illustrated in FIG. 7 (step S6). This flag operation is executed, for example, on the buffer 7. Thereafter, data of the whole physical sector (first physical sector) changed only in REAS flags as illustrated in FIG. 7 are reassigned to a different physical sector (second physical sector) for data reassignment on the medium 3 (step S7).

On the medium 3, it is also possible to provide a physical sector for the reassign area separately from a physical sector used to record ordinary data. For example, as illustrated on the medium 3 in FIG. 9, the medium 3 may be configured to include an ordinary area 31 used to record user data at first and a reassign area 32 separately provided for data reassignment. In this case, all reassigned data are recorded in the reassign area 32. The reassign area 32 may not be fan shaped as illustrated in FIG. 9, but may be disposed in a ring form in a certain range in the diameter direction. The disposition place of the reassign area is not restricted. Data which becomes the object of reassignment is at first recorded in the ordinary area 31. However, if the reassignment is repeated, it is also possible that data is reassigned from an already recorded physical sector in the reassign area 32 to a different physical sector which is not used in the reassign area 32.

Referring back to FIG. 4, if the data reassignment finishes normally at step S7, the host 1 is notified of normal end of the REASSIGN BLOCKS command at step S8. If the reassign area 32 is used up and data reassignment cannot be conducted at this time, the host 1 is notified that the REASSIGN BLOCKS command cannot be executed at step S8. The processing in cases where the REASSIGN BLOCKS command is issued for LBA=4 in the state illustrated in FIG. 6 by the host 1 is finished as described heretofore.

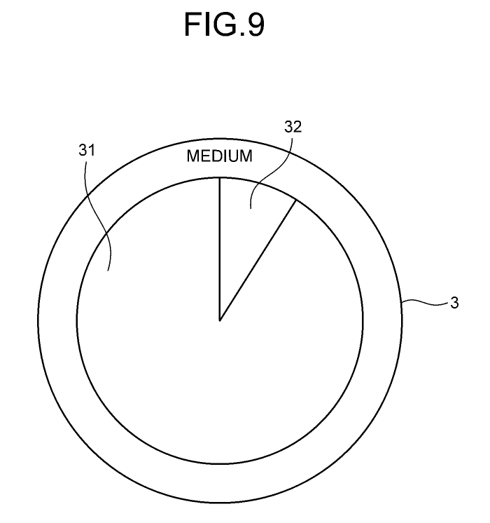

Hereafter, a case (the step S1) in which the host 1 further issues the REASSIGN BLOCKS command to LBA=0 in a state after data of LBA =0 to 7 from the first physical sector are reassigned to the second physical sector as illustrated in FIG. 7 will be described. At the step S2, a REAS flag of a logical sector that becomes an object of the REASSIGN BLOCKS command is checked. Since the REAS flag of the logical sector of LBA=0 is “1” at the step S3 (step S3: Yes), the REAS flag of the logical sector of LBA=0 is reset to “0” as illustrated in FIG. 8 (step S4). In this case, substantial data reassign processing is not conducted (step S5). In other words, only a flag operation in a different physical sector (the second physical sector) is conducted in this case. Finally, the host 1 is notified of normal end of the REASSIGN BLOCKS command at the step S8. Even if the host 1 issues the REASSIGN BLOCKS command for a logical sector that is set to “1” in REAS flag, data reassignment is not actually conducted, but only resetting the REAS flag of the logical sector to “0” is conducted in this way. It should be noted that the state indicated by “0” or “1” in the REAS flag may be reversed as compared with that in the above-described example. In the same way, “set” and “reset” may be used reversely.

In cases where the REASSIGN BLOCKS command is issued for a logical sector (LBA32 4) included in a certain physical sector and in addition the REASSIGN BLOCKS command is issued for a different logical sector (LBA=0) included in the same physical sector, reassignment of a physical sector is executed each time in the prior art. In other words, it is conducted in the prior art to reassign a physical sector immediately after reassignment to a different reassign area 32 again, resulting in a problem of wasteful consumption of the reassign area 32. However, if the host 1 issues a plurality of reassign commands for different logical sectors in the same physical sector and reassignment of a physical sector is executed once, the data reassign method in the present embodiment makes it possible to cope with ensuing reassign commands by only operating REAS flags without repeating reassignment of the physical sector. As a result, wasteful consumption of the reassign area 32 can be reduced. Furthermore, as compared with management of reassign history using a table, management using flags becomes profitable in memory consumption and processing speed. Furthermore, it becomes possible to reduce the number of times of writing.

In cases where the medium 3 is mounted as illustrated in FIG. 9, only the REAS flags in the reassign area 32 become effective. Therefore, REAS flags recorded in physical sectors in the ordinary area 31 other than the reassign area 32 may be disregarded. Or mounting in which REAS flags are not prepared in physical sectors in the ordinary area 31 from the beginning is also possible. In this case, whether there is a REAS flag area should also be checked at the step S3. Cases where there are not the REAS flag area should also be included in cases of (step S3: No) and the processing should proceed to the step S6. In other words, if a reassign command is issued for a logical sector in the ordinary area 31 which is not the reassign area 32, data in a physical sector including the logical sector is reassigned to the reassign area 32 without fail.

With respect to a plurality of reassign commands for different logical sectors in the same physical sector from the host, reassignment of the physical sector is not repeated after reassignment of the physical sector is executed once, according to the embodiment. As a result, it is possible to obtain an effect that wasteful consumption of the reassign area can be reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data reassign method performed in a storage device having a recording medium, the method of rewriting data on the recording medium by taking a physical sector including a plurality of logical sectors each forming a management unit in a command from a host, as a management unit, in response to receipt of a reassign command for rewriting data on the recording medium into a different area from the host, the method comprising:
when a reassign command specifying a first logical sector included in a first physical sector and that has not been specified yet by the reassign command is received, reassigning data in the first physical sector to a second physical sector different from the first physical sector; and
refraining thereafter from reassigning data in the second physical sector until occurrence of either re-receipt of the reassign command for the first logical sector or second-time or later receipt of a reassign command for a second logical sector other than the first logical sector included in the second physical sector.

2. The method of claim 1, wherein when either the re-receipt or the second-time receipt has occurred, data in the second physical sector is reassigned to a physical sector different from the first and second physical sectors.

3. The method of claim 1, wherein
the physical sector includes management information which corresponds to each of the logical sectors included in the physical sector and which indicates whether there is execution of reassignment of the logical sector,
when a reassign command is received for a logical sector having the management information indicating that there is execution of the reassignment, data in the physical sector is not reassigned, and
when a reassign command is received for a logical sector having the management information indicating that there is no execution of the reassignment, data in the physical sector is reassigned.

4. The method of claim 2, wherein
the physical sector includes management information which corresponds to each of the logical sectors included in the physical sector and which indicates whether there is execution of reassignment of the logical sector,
if a reassign command is received for a logical sector having the management information indicating that there is execution of the reassignment, data in the physical sector is not reassigned, and
if a reassign command is received for a logical sector having the management information indicating that there is no execution of the reassignment, data in the physical sector is reassigned.

5. The method of claim 3, wherein at first all of the management information included in the physical sector indicates that there is no execution of the reassignment.

6. The method of claim 4, wherein at first all of the management information included in the physical sector indicates that there is no execution of the reassignment.

7. The method of claim 3, wherein
when the reassign command specifying the first logical sector included in the first physical sector and that has not been specified yet by the reassign command is received, all of the management information of logical sectors other than the first logical sector in the second physical sector after reassignment is set to “there is execution of the reassignment,” and
when the reassign command is received thereafter for a logical sector having the management information set to “there is execution of the reassignment” in the second physical sector, the management information is set to “there is no execution of the reassignment.”

8. The method of claim 4, wherein
when the reassign command specifying the first logical sector included in the first physical sector and that has not been specified yet by the reassign command is received, all of the management information of logical sectors other than the first logical sector in the second physical sector after reassignment is set to “there is execution of the reassignment,” and
when the reassign command is received thereafter for a logical sector having the management information set to “there is execution of the reassignment” in the second physical sector, the management information is set to “there is no execution of the reassignment.”

9. The method of claim 1, wherein a physical sector before the reassignment does not include management information which corresponds to each of the logical sectors included in the physical sector and which indicates whether there is execution of reassignment of the logical sector, and a physical sector reassigned to an area configured to retain reassigned data on the recording medium includes the management information.

10. The method of claim 1, wherein when a reassign command for a logical sector in an ordinary area which is not an area configured to retain reassigned data on the recording medium is received from the host, data in a physical sector including logical sector corresponding to the received reassign command is reassigned from the ordinary area to an area configured to retain the reassigned data different from the ordinary area.

11. A storage device comprising;
a recording medium configured to store a physical sector including a plurality of logical sectors each forming a management unit in a host;
a host interface configured to receive a reassign command specifying reassignment of rewriting data on the recording medium into a different area on the recording medium in logical sector unit, from the host; and
a controller configured to, when a reassign command specifying a first logical sector included in a first physical sector and that has not been specified yet by the reassign command is received via the host interface, reassign data in the first physical sector to a second physical sector different from the first physical sector, and to refrain thereafter from reassigning data in the second physical sector until occurrence of either re-receipt of the reassign command for the first logical sector or second-time or later receipt of a reassign command for a second logical sector other than the first logical sector included in the second physical sector.

12. The storage device of claim 11, wherein when either the re-receipt or the second-time receipt has occurred, the controller reassigns data in the second physical sector to a physical sector different from the first and second physical sectors.

13. The storage device of claim 11, wherein
the physical sector includes management information which corresponds to each of the logical sectors included in the physical sector and which indicates whether there is execution of reassignment of the logical sector,
when a reassign command is received for a logical sector having the management information indicating that there is execution of the reassignment via the host interface, the controller does not reassign data in the physical sector, and
when a reassign command is received for a logical sector having the management information indicating that there is no execution of the reassignment via the host interface, the controller reassigns data in the physical sector.

14. The storage device of claim 12, wherein the physical sector includes management information which corresponds to each of the logical sectors included in the physical sector and which indicates whether there is execution of reassignment of the logical sector,
when a reassign command is received for a logical sector having the management information indicating that there is execution of the reassignment via the host interface, the controller does not reassign data in the physical sector, and
when a reassign command is received for a logical sector having the management information indicating that there is no execution of the reassignment via the host interface, the controller reassigns data in the physical sector.

15. The storage device of claim 13, wherein at first all of the management information included in the physical sector indicates that there is no execution of the reassignment.

16. The storage device of claim 14, wherein at first all of the management information included in the physical sector indicates that there is no execution of the reassignment.

17. The storage device of claim 13, wherein
when the reassign command specifying the first logical sector included in the first physical sector and that has not been specified yet by the reassign command is received, the controller sets all of the management information of logical sectors other than the first logical sector in the second physical sector after reassignment to “there is execution of the reassignment,” and
when the reassign command is received thereafter for a logical sector having the management information set to “there is execution of the reassignment” in the second physical sector, the controller sets the management information to “there is no execution of the reassignment.”

18. The storage device of claim 14, wherein
when the reassign command specifying the first logical sector included in the first physical sector and that has not been specified yet by the reassign command is received, the controller sets all of the management information of logical sectors other than the first logical sector in the second physical sector after reassignment to “there is execution of the reassignment,” and
when the reassign command is received thereafter for a logical sector having the management information set to “there is execution of the reassignment” in the second physical sector, the controller sets the management information to “there is no execution of the reassignment.”

19. The storage device of claim 11, wherein a physical sector before the reassignment does not include management information which corresponds to each of the logical sectors included in the physical sector and which indicates whether there is execution of reassignment of the logical sector, and a physical sector reassigned to an area configured to retain reassigned data on the recording medium includes the management information.

20. The storage device of claim 11, wherein when a reassign command for a logical sector in an ordinary area which is not an area configured to retain reassigned data on the recording medium is received via the host interface, the controller reassigns data in a physical sector including logical sector corresponding to the received reassign command from the ordinary area to an area configured to retain the reassigned data different from the ordinary area.
